(19) United States
(12) Patent Application Publication
(10) Pub. No.: US 2013/0074742 A1
(43) Pub. Date: Mar. 28, 2013

(54) Electronic Device Carrier

(71) Applicant: Chih-Sheng Hsieh, Hualien County (TW)

(72) Inventor: Chih-Sheng Hsieh, Hualien County (TW)

(21) Appl. No.: 13/625,146

(22) Filed: Sep. 24, 2012

(30) Foreign Application Priority Data
Sep. 22, 2011 (TW) 100134091

(51) Int. Cl. A47B 23/06; B60R 11/02; A47B 23/00

(52) U.S. Cl. CPC A47B 23/06; A47B 23/00; B60R 11/02
USPC 108/49; 224/275

(57) ABSTRACT

The present invention relates to a electronic device carrier comprising:

a fixed part, set the side of the bed or the seat of transport; and a carring part, configured with one or several fixed components or notches, could be fixed on the door or fixed on the transport by said fixed part, and could be integrated with said fixed part. With above said design and structure, users could put the electronic device on the carrying part so that they could watch video and visit the internet while they are on the bed or in the car, get the better using of the time and space.

The current application claims a foreign priority to the patent application of Taiwan No. 100134091 filed on Sep. 22, 2011. The statutory foreign priority claiming period ended on Sep. 22, 2012 when was on a weekend. Therefore, the application is filed on the next business day on Sep. 24, 2012.

### BACKGROUND OF THE INVENTION

1. Field of the Invention

The present invention relates to a carrier, particularly it pertains to a electronic device carrier which could let users put the electronic device on the carrying part so that they could watch video and visit the internet while they are on the bed or in the car, get the better using of the time and space.

2. Description of the Related Art

The transport such as car and motorcycle almost becomes the necessary tools for people.

The current communication devices for transport are GPS device, transport computer, transport monitor, etc. All of said devices are so expensive and wasting space that they are not used widely.

The smart phone and IPAD now are used to replace said devices due to they can install APP for providing GPS function, video playing, sound playing, web browsing.

Because the space in the transport is not enough, users have to put them on the legs for long time operating. It is not also inconvenient, but also dangerous for the passengers and divers.

### SUMMARY OF THE INVENTION

The inventor of the present invention has spent years researching and developing a carrier which could let users put the electronic device on the carrying part so that they could watch video and visit the internet while they are on the bed or in the car, get the better using of the time and space..

The present invention comprises a fixed part, set the side of the bed or the seat of transport; and a carring part, configured with one or several fixed components or notches, could be fixed on the door or fixed on the transport by said fixed part, and could be integrated with said fixed part.

The main aim of the present invention is to provide a carrier which could let users could put the electronic device on the carrying part so that they could watch video and visit the internet while they are on the bed or in the car, get the better using of the time and space.

### BRIEF DESCRIPTION OF THE DRAWINGS

FIG. 1 is a diagram showing the first embodiment of the present invention.

FIG. 2 is a diagram showing the second embodiment of the present invention.

FIG. 3 is a diagram showing the third embodiment of the present invention.

### DETAILED DESCRIPTION OF THE PREFERRED EMBODIMENT

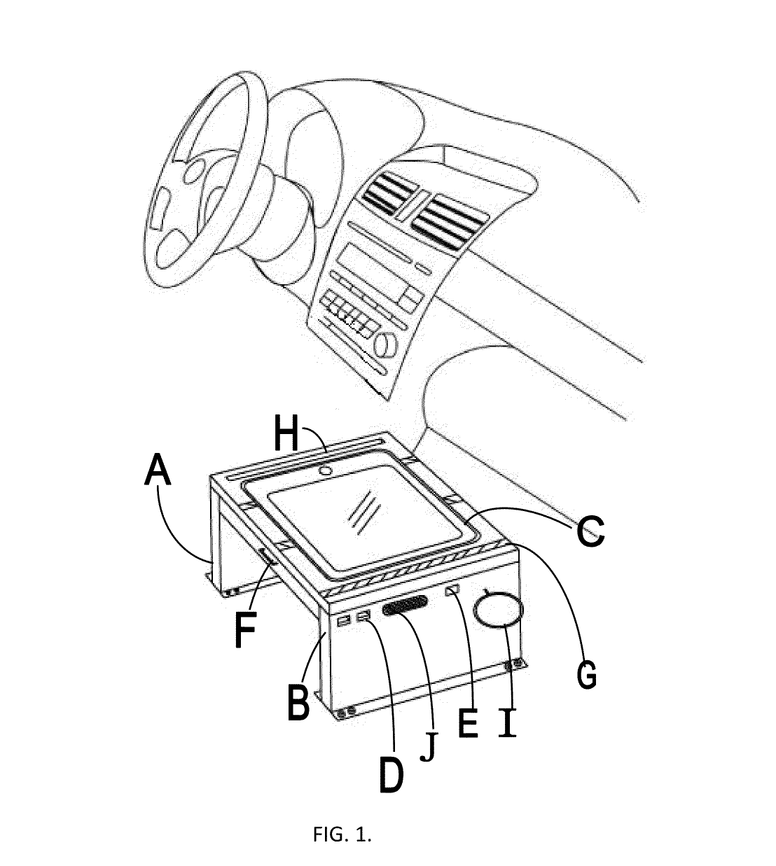

Please refer to FIG. 1, FIG. 1 is a diagram showing the first embodiment of the present invention. The present invention comprising: a fixed part A, set the side of the bed or the seat of transport; and a carring part B, could be fixed on the door or fixed on the transport by said fixed part A, and could be integrated with said fixed part A. With above said design and structure, users could put the electronic device C on the carrying part B so that they could watch video and visit the internet while they are on the bed or in the car, get the better using of the time and space.

Wherein said carrying part B could configured with a power supply. wherein said fixed part A could be velcro objects, riveting objects, latches, suction objects, stick objects, fastenings, concave and convex objects, zippers, screws, fixed bolts or clamping objects.

Wherein said fixed part A could be set on the door or the transport or could be set between the seats, said fixed A part could be collapsible or shrinkable.

Wherein a plate could be configured to cover the one or several notches of said carrying part B, said plate is openable, retractable or removable

One or several USB connecting ports D or external electronic ports could be configured on said fixed part A or carrying part B for connecting with the other electronic devices C; one or several of the bluetooth device, the infrared device E, the network hub or the wireless network could be configured on said fixed part A or carrying part B for users sharing the files or resource of the electronic devices C to each other.

Wherein said fixed part A or carrying part B or both could be integrated with the parts of transport.

Wherein said carrying part B could be configured with one or more storage spaces F and said storage spaces F could be configured with opening and closing structure.

Wherein said carrying part B could be configured with frames, straps, card boards, card slots, fixed rings, holders, card blocks, or latches to hold or fixed the electronic devices; said carrying part B could be configured a rough surface G, or configured with the gasket or shield to increase friction; said carrier part B could be portability, removable, retractable, foldable, rotatable or attachable; wherein said fixed part A or carrying part B or both could be portable, removable, scalable, collapsible or rotateable; said fixed part A or carrying part B or both could be configured with groove H or hollow ring I for drinks or container.

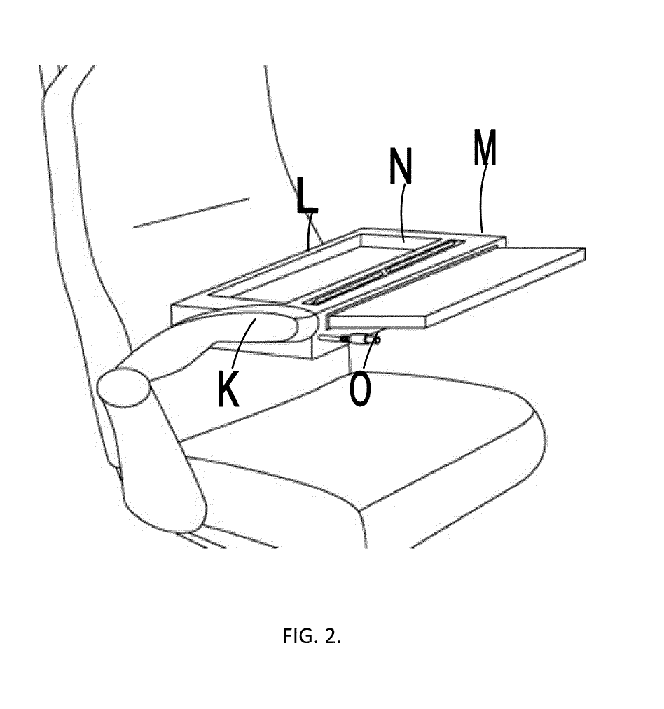

Please refer to FIG. 2, FIG. 2 is a diagram showing the second embodiment of the present invention. The present invention comprising: a fixed part K, set the side of the bed or the seat of transport; and a carring part L, configured with one or several fixed components M or notches N for fixing the electronic devices, could be fixed on the door or fixed on the transport by said fixed part K, and could be integrated with said fixed part K. With above said design and structure, users could put the electronic device on the carrying part L so that they could watch video and visit the internet while they are on the bed or in the car, get the better using of the time and space.

said carrying part L could be configured with a plate or tablet for supporting the huger electronic device; said carrying part L could be configured with a bracket for standing on the ground, the angle of bracket could be adjustable and the length of the bracket could be adjustable; said fixed part K or carrying part L or both could be configured with light objects, speakers or power supply O.

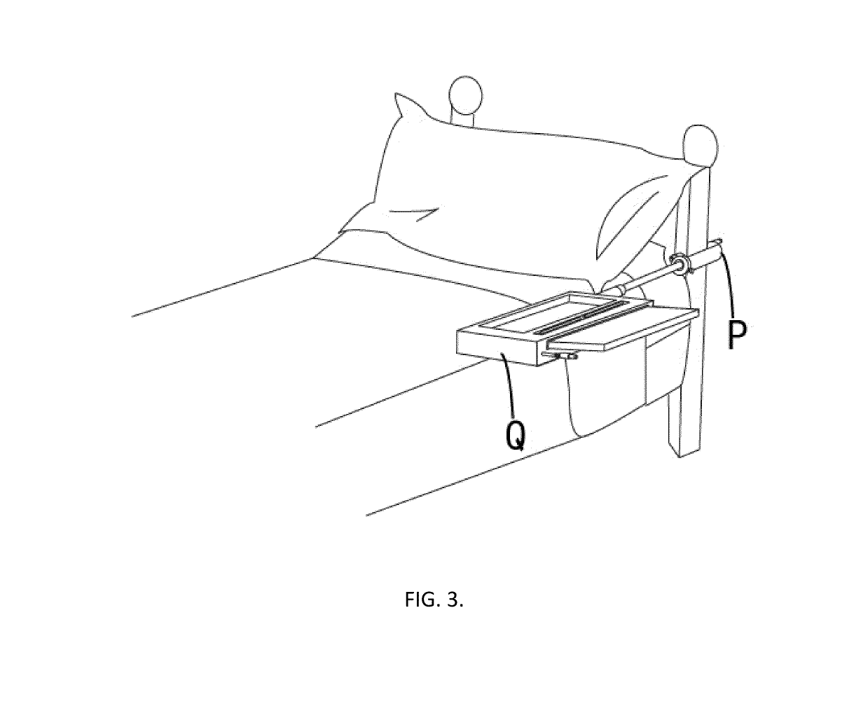

Please refer to FIG. 3, FIG. 3 is a diagram showing the third embodiment of the present invention. The different point from first embodiment and second embodiment is that the fixed part P could be set at the surrounding of the bed. Users could put the electronic device on the carrying part Q.

As is understood by a person skilled in the art, the foregoing preferred embodiment of the present invention is an illustration, rather than a limiting description of the present invention. It is intended to cover various modifications and similar arrangements, for example, the material of carrying part, and the position of the fixed componet etc., all the above may vary and should be considered within the spirit and scope of the appended claims of the present invention. In short, the spirit and scope should be accorded the broadest interpretation so as to encompass all such modifications and similar structures.

1. An Electronic Device Carrier comprising:
A fixed part, set the side of the bed or the seat of transport; and
A caning part, configured with one or several fixed components or notches, could be fixed on the door or fixed on the transport by said fixed part, and could be integrated with said fixed part;
with above said design and structure, users could put the electronic device on the carrying part so that they could watch video and visit the internet while they are on the bed or in the car, get the better using of the time and space.

2. The Electronic Device Carrier as in claim 1, wherein said carrying part could configured with a power supply.

3. The Electronic Device Carrier as in claim 1, wherein said fixed part could be velcro objects, riveting objects, latches, suction objects, stick objects, fastenings, concave and convex objects, zippers, screws, fixed bolts or clamping objects.

4. The Electronic Device Carrier as in claim 1, wherein said fixed part could be set on the door or the transport or could be set between the seats, said fixed part could be collapsible or 20 shrinkable.

5. The Electronic Device Carrier as in claim 2, wherein said fixed part could be set on the door or the transport or could be set between the seats, said fixed part could be collapsible or 20 shrinkable.

6. The Electronic Device Carrier as in claim 1, wherein a plate could be configured to cover the one or several notches of said carrying part, said plate is openable, retractable or removable.

7. The Electronic Device Carrier as in claim 2, wherein a plate could be configured to cover the one or several notches of said carrying part, said plate is openable, retractable or removable.

8. The Electronic Device Carrier as in claim 1, one or several USB connecting ports or external electronic ports could be configured on said fixed part or carrying part for connecting with the other electronic devices; one or several of the bluetooth device, the infrared device, the network hub or the wireless network could be configured on said fixed part or carrying part for 5 users sharing the files or resource of the electronic devices to each other.

9. The Electronic Device Carrier as in claim 2, one or several USB connecting ports or external electronic ports could be configured on said fixed part or carrying part for connecting with the other electronic devices; one or several of the bluetooth device, the infrared device, the network hub or the wireless network could be configured on said fixed part or carrying part for 5 users sharing the files or resource of the electronic devices to each other.

10. The Electronic Device Carrier as in claim 1, wherein said fixed part or carrying part or both could be integrated with the parts of transport.

11. The Electronic Device Carrier as in claim 2, wherein said fixed part or carrying part or both could be integrated with the parts of transport.

12. The Electronic Device Carrier as in claim 1, wherein said carrying part could be configured with one or more storage spaces and said storage spaces could be configured with opening and closing structure.

13. The Electronic Device Carrier as in claim 2, wherein said carrying part could be configured with one or more storage spaces and said storage spaces could be configured with opening and closing structure.

14. The Electronic Device Carrier as in claim 1, wherein 15 said carrying part could be configured with frames, straps, card boards, card slots, fixed rings, holders, card blocks, or latches to hold or fixed the electronic devices; said carrying part could be configured a rough surface, or configured with the gasket or shield to increase friction; said carrier part could be portability, removable, retractable, 20 foldable, rotatable or attachable; said carrying part could be
configured with a plate or tablet for supporting the huger electronic device; said carrying part could be configured with a bracket for standing on the ground, the angle of bracket could be adjustable and the length of the bracket could be adjustable.

15. The Electronic Device Carrier as in claim 2, wherein 15 said carrying part could be configured with frames, straps, card boards, card slots, fixed rings, holders, card blocks, or latches to hold or fixed the electronic devices; said carrying part could be configured a rough surface, or configured with the gasket or shield to increase friction; said carrier part could be portability, removable, retractable, 20 foldable, rotatable or attachable; said carrying part could be
configured with a plate or tablet for supporting the huger electronic device; said carrying part could be configured with a bracket for standing on the ground, the angle of bracket could be adjustable and the length of the bracket could be adjustable.

16. The Electronic Device Carrier as in claim 1, wherein said fixed part or carrying part or both could be portable, removable, scalable, collapsible or rotateable; said fixed part or carrying part or both could be configured with groove or hollow ring for drinks or container; said fixed part or carrying 5 part or both could be configured with light objects or speakers or both.

17. The Electronic Device Carrier as in claim 2, wherein said fixed part or carrying part or both could be portable, removable, scalable, collapsible or rotateable; said fixed part or carrying part or both could be configured with groove or hollow ring for drinks or container; said fixed part or carrying 5 part or both could be configured with light objects or speakers or both.
